(19) United States
(12) Patent Application Publication
(10) Pub. No.: US 2026/0012471 A1
(43) Pub. Date: Jan. 8, 2026

(54) SYSTEM AND METHOD FOR DETECTING ANOMALIES WITHIN AN INDUSTRIAL CONTROL NETWORK

(71) Applicant: Honeywell International Inc., Charlotte, NC (US)

(72) Inventors: Harshal Haridas, PIPERSVILLE, PA (US); Shivam Gupta, Bengaluru (IN)

(21) Appl. No.: 18/764,421

(22) Filed: Jul. 5, 2024

(51) Int. Cl. H04L 9/40; G05B 23/02

(52) U.S. Cl. CPC H04L 63/1425; G05B 23/0243

(57) ABSTRACT

A method for detecting anomalies within an industrial control network is disclosed. The method comprises receiving asset data from one or more assets of an industrial control network in real time; correlating the asset data with a predefined functional data; determining anomaly data within the correlated asset data based at least on a weight factor and an anomaly score, using an unsupervised model; categorizing the anomaly data into one or more groups of anomaly data based at least on a number of clusters, using at least a supervised or unsupervised model; assigning a weight to each group of anomaly data; determining whether the weight assigned to each group is above a preset threshold value; and generating an alert associated with each group, for a user upon determining the weight assigned to each group is above the preset threshold value, that corresponds to anomalous events detected within the industrial control network.

### TECHNOLOGICAL FIELD

The present invention relates to cybersecurity systems, and more particularly relates to a system and a method for detecting anomalies within an industrial control network.

### BACKGROUND

Operational Technology (OT) Managed Detection and Response (MDR) and Security Operations Centers (SOC)'s market is rapidly evolving to meet unique challenges posed by industrial control networks and critical infrastructure. OT MDR and SOC solutions primarily focus on collecting data from Process Control Networks (PCN) and various OT nodes. The collected data is then analyzed to build actionable insights and generate alerts for anomalies, which SOC analysts can investigate and respond to. The generated alerts in cybersecurity solutions are vital for protecting the integrity and functionality of OT networks, ensuring that industrial operations remain secure from cyber threats. However, the cybersecurity solutions typically operate solely within the cyber domain of OT networks, without integrating data from the physical aspects of plant operations. Simultaneously, a separate set of solutions exists for plant safety, which focuses on collecting and analyzing data from control systems and cyber-physical systems. The set of solutions are designed to assess and ensure plant safety by correlating data of cyber-physical system to detect and respond to hazardous conditions. Typically, the OT technology keeps the cybersecurity and plant safety solutions entirely independent of one another. Such separation creates significant gaps in incident detection and response capabilities. As a result, SOC analysts often spend considerable time performing root cause analysis without access to potentially critical physical system data. Moreover, insider attacks and physical intrusions can go unnoticed by the cyber-physical system and plant safety solutions alike, due to isolated data sets and lack of integrated analysis.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In one example embodiment, a method for detecting anomalies within an industrial control network is disclosed. The method comprises receiving, via at least one processor, asset data from one or more assets of the industrial control network in a real time. The asset data comprises at least one of identification data, configuration data, operational data, health and diagnostics data, time data, or location data associated with the one or more assets. Further, the method comprises correlating, via the at least one processor, the asset data received from the one or more assets with a predefined functional data. The predefined functional data corresponds to functionalities of each of the one or more assets and interactions between the one or more assets. Further, the method comprises determining, via the at least one processor, anomaly data within the correlated asset data of the one or more assets based at least on a weight factor and an anomaly score, using an unsupervised model. Further, the method comprises categorizing, via the at least one processor, the determined anomaly data into one or more groups of anomaly data based at least on a number of clusters, using at least a supervised or unsupervised model. Further, the method comprises assigning, via the at least one processor, a weight to each of the one or more groups of anomaly data. Further, the method comprises determining, via the at least one processor, whether the weight assigned to each of the one or more groups is above a preset threshold value. The preset threshold value corresponds to a minimum value above which an anomaly is detected. Thereafter, the method comprises generating, via the at least one processor, an alert associated with each of the one or more groups, for a user upon determining the weight assigned to each of the one or more groups is above the preset threshold value. The alert associated with each of the one or more groups of anomaly data corresponds to one or more anomalous events detected within the industrial control network.

In some embodiments, the one or more assets comprise at least one of radar surveillance, badge access, video surveillance, USB insights, host insights, network insights, or network data recorder (NDR).

In some embodiments, the anomaly data corresponds to deviation of data from normal or expected behavior of the one or more assets within the industrial control network indicating potential problems, security breaches, or inefficiencies within the industrial control network.

In some embodiments, determining the anomaly data within the correlated asset data of the one or more assets using the unsupervised model further comprising converting, via the at least one processor, one or more columns of the correlated asset data into a numeric value, using a label encoder; assigning, via the at least one processor, the weight factor to each of the one or more columns, using a random forest technique; determining, via the at least one processor, the anomaly score for each correlated asset data based at least on the assigned weight and a predefined threshold value, wherein the anomaly score indicates a degree of anomaly of the correlated asset data; and determining, via the at least one processor, the anomaly data within the correlated asset data based at least on the anomaly score.

In some embodiments, the one or more columns correspond to time, asset, activity, information, asset node ID, asset description, badge access insights, and video surveillance associated with the one or more assets.

In some embodiments, the method further comprising determining, via the at least one processor, the number of clusters dynamically from the determined anomaly data, using an elbow management technique.

In some embodiments, the method further comprising determining anomaly data within a respective group of anomaly data using the unsupervised model upon determining the weight assigned to each of the one or more groups is below the preset threshold value.

In some embodiments, the method further comprising sending, via the at least one processor, the alert to the user for taking an action in response to the one or more anomalous events detected within the industrial control network.

In another example embodiment, a system for detecting anomalies within an industrial control network is disclosed. The system comprises a memory and at least one processor communicatively coupled to the memory. The at least one processor is configured to receive asset data from one or more assets of an industrial control network in a real time. The asset data comprises at least one of identification data, configuration data, operational data, health and diagnostics data, time data, or location data associated with the one or more assets. Further, the at least one processor is configured to correlate the asset data received from the one or more assets with a predefined functional data. The predefined functional data corresponds to functionalities of each of the one or more assets and interactions between the one or more assets. Further, the at least one processor is configured to determine anomaly data within the correlated asset data of the one or more assets based at least on a weight factor and an anomaly score, using an unsupervised model. Further, the at least one processor is configured to categorize the determined anomaly data into one or more groups of anomaly data based at least on a number of clusters, using at least a supervised or unsupervised model. Further, the at least one processor is configured to assign a weight to each of the one or more groups of anomaly data. Further, the at least one processor is configured to determine whether the weight assigned to each of the one or more groups is above a preset threshold value. The preset threshold value corresponds to a minimum value above which an anomaly is detected. Thereafter, the at least one processor is configured to generate an alert associated with each of the one or more groups, for a user upon determining the weight assigned to each of the one or more groups is above the preset threshold value. The alert associated with each of the one or more groups correspond to one or more anomalous events detected within the industrial control network.

In another example embodiment, a non-transitory machine-readable information storage medium for detecting anomalies within an industrial control network is disclosed. The non-transitory machine-readable information storage medium comprising one or more instructions which when executed by at least one processor cause the at least one processor to: receive asset data from one or more assets of an industrial control network in a real time, wherein the asset data comprises at least one of identification data, configuration data, operational data, health and diagnostics data, time data, or location data associated with the one or more assets; correlate the asset data received from the one or more assets with a predefined functional data, wherein the predefined functional data corresponds to functionalities of each of the one or more assets and interactions between the one or more assets; determine anomaly data within the correlated asset data of the one or more assets based on a weight factor and anomaly score, using an unsupervised model; categorize the determined anomaly data into one or more groups of anomaly data based at least on a number of clusters, using at least a supervised or unsupervised model; assign a weight to each of the one or more groups of anomaly data; determine whether the weight assigned to each of the one or more groups is above a preset threshold value, wherein the preset threshold value corresponds to a minimum value above which an anomaly is detected; and generate an alert associated with each of the one or more groups, for a user upon determining the weight assigned to each of the one or more groups is above the preset threshold value, wherein the alert associated with each of the one or more groups correspond to one or more anomalous events detected within the industrial control network.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a network diagram of a system for detecting anomalies within an industrial control network in accordance with an example embodiment of the present disclosure;

FIG. 2 illustrates a block diagram of a server in accordance with an example embodiment of the present disclosure;

FIG. 3 illustrates an overview of the system for detecting anomalies within the industrial control network in accordance with an example embodiment of the present disclosure;

FIG. 4 illustrates a detailed block diagram of the system for detecting anomalies within the industrial control network in accordance with an example embodiment of the present disclosure;

FIG. 5 illustrates a block diagram showing flow of asset data usage within the system for detecting anomalies within the industrial control network in accordance with an example embodiment of the present disclosure;

FIG. 6 illustrates a database of a predefined functional data in accordance with an example embodiment of the present disclosure;

FIG. 7 illustrates a database of correlated asset data in accordance with an example embodiment of the present disclosure; and

FIG. 8 illustrates a flowchart showing a method for detecting anomalies within the industrial control network in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. As discussed herein, the protection devices may be referred to use by humans, but may also be used to raise and lower objects unless otherwise noted.

The components illustrated in the figures represent components that may or may not be present in various embodiments of the invention described herein such that embodiments may include fewer or more components than those shown in the figures while not departing from the scope of the invention. Some components may be omitted from one or more figures or shown in dashed line for visibility of the underlying components.

The present disclosure provides various embodiments of methods and systems for detecting anomalies within an industrial control network. Embodiments may be configured to be executed by at least one processor. Embodiments may be configured to receive asset data from one or more assets of an industrial control network in a real time. The asset data may comprise at least one of identification data, configuration data, operational data, health and diagnostics data, time data, or location data associated with the one or more assets. Embodiments may be configured to correlate the asset data received from the one or more assets with a predefined functional data. The predefined functional data may correspond to functionalities of each of the one or more assets and interactions between the one or more assets. Embodiments may be configured to determine anomaly data within the correlated asset data of the one or more assets based at least on a weight factor and an anomaly score, using an unsupervised model. Embodiments may be configured to categorize the determined anomaly data into one or more groups of anomaly data based at least on a number of clusters, using at least a supervised or unsupervised model. Embodiments may be configured to assign a weight to each of the one or more groups of anomaly data. Embodiments may be configured to determine whether the weight assigned to each of the one or more groups is above a preset threshold value. The preset threshold value corresponds to a minimum value above which an anomaly is detected. Embodiments may be configured to generate an alert associated with each of the one or more groups, for a user upon determining the weight assigned to each of the one or more groups is above the preset threshold value. The alert associated with each of the one or more groups may correspond to one or more anomalous events detected within the industrial control network.

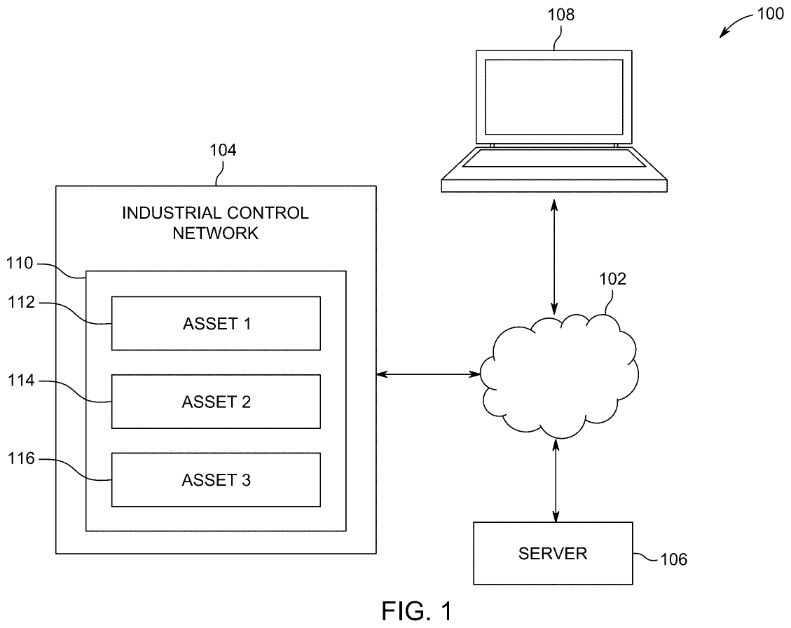

FIG. 1 illustrates a network diagram of a system 100 for detecting anomalies within an industrial control network 104, in accordance with an example embodiment of the present disclosure. The system 100 may comprise a network 102 communicatively coupled to the industrial control network 104, a server 106, and a user device 108.

In some embodiments, the network 102 may be a communication network such as internet or a cloud network, that may be configured to allow the industrial control network 104, the server 106 and the user device 108 to communicate with each other through wired network, wireless network, or a combination of both. In some embodiments, the network 102 may refer to as a distributed infrastructure that is configured to exchange of data, information, and resources among interconnected computing devices and systems. The network 102 may be designed to facilitate communication and collaboration across various locations, devices, and platforms. Those skilled in the art will recognize that wired devices may include, but are not limited to, wired networks such as Wide Area Networks (WANs) or Local Area Networks (LANs), while wireless devices may include wireless communications established via Radio Frequency (RF) signals or infrared signals. Various devices in the system 100 may connect to the network 102 in accordance with various wired and wireless communication protocols such as Transmission Control Protocol and Internet Protocol (TCP/IP), User Datagram Protocol (UDP), and 2G, 3G, or 4G communication protocols.

In some embodiments, the industrial control network 104 may correspond to a complex system of interconnected devices, software, and protocols designed to monitor, control, and automate industrial processes in sectors such as manufacturing, energy, transportation, and utilities. The industrial control network 104 may facilitate the seamless operation of industrial facilities by enabling real-time monitoring of equipment, processes, and environmental conditions, as well as providing the means to remotely control and optimize operations. The industrial control network 104 may utilize one or more assets 110 comprising a first asset 112 denoted as “Asset 1”, a second asset 114 denoted as “Asset 2”, and a third asset 116 denoted as “Asset 3”. The one or more assets 110 may be configured to gather data, analyze performance, and execute commands within the industrial control network 104.

In one example embodiment, each of the one or more assets 110 may correspond to at least one of radar surveillance, badge access, video surveillance, USB insights, host insights, network insights, or network data recorder (NDR). The industrial control network 104 may enhance efficiency, productivity, and safety in industrial operations by automating processes, minimizing downtime, optimizing resource utilization, and ensuring compliance with regulatory standards. Additionally, the industrial control network 104 may enable centralized management and remote monitoring of industrial facilities, allowing operators to make informed decisions, respond to emergencies, and adapt to changing conditions in real-time.

In some embodiments, the server 106 may be a computer or software module that is configured to provide centralized resources, data, or services to the user device 108 operated by a user. The server 106 may be configured to handle and manage one or more computational tasks and data processing within the system 100. In some embodiments, the server 106 may include storage systems, such as hard drives or storage arrays, to store and manage large volumes of data and information accessible to network users. In some embodiments, the server 106 may further provide centralized control and management capabilities, allowing network administrators to configure, monitor, and maintain network resources, security settings, and user access permissions from a single location.

In some embodiments, the server 106 may be configured to receive asset data from one or more assets 110 of an industrial control network 104 in a real time. The asset data may comprise at least one of identification data, configuration data, operational data, health and diagnostics data, time data, or location data associated with the one or more assets 110. The identification data may serve as a unique identifier for each asset, allowing for accurate tracking and referencing. The identification data may include serial numbers, barcodes, or other identifying information specific to each asset. The configuration data may delve into the setup and parameters of an asset, detailing specifications, settings, and any customizations applied. The configuration data may ensure that assets are properly configured for their intended use, optimizing their performance within the system 100.

The operational data may provide insights into the day-to-day functioning of assets, capturing metrics such as usage patterns, activity levels, and performance indicators. The operational data may be used for assessing asset efficiency, identifying any operational issues, and optimizing resource allocation. The health and diagnostics data may offer a glimpse into the overall health and condition of assets, including any faults, errors, or maintenance requirements. It may be noted that monitoring the health and diagnostics data may enable proactive maintenance strategies, minimize downtime, and maximize asset lifespan.

The time data may record temporal aspects of asset operations, documenting when events occur, durations, and intervals between activities. The temporal aspects may be used for analyzing trends, scheduling maintenance tasks, and understanding asset behavior over time. The location data may provide spatial information about asset whereabouts, tracking their physical locations within the system 100. The location data may be used for asset logistics, inventory management, and ensuring deployment of the assets effectively.

In some embodiments, the server 106 may be configured to correlate the asset data received from the one or more assets 110 with a predefined functional data. The predefined functional data may correspond to functionalities of each of the one or more assets 110 and interactions between the one or more assets 110. In some embodiments, the server 106 may further be configured to determine anomaly data within the correlated asset data of the one or more assets 110 based at least on a weight factor and an anomaly score, using an unsupervised model.

In some embodiments, the server 106 may be configured to categorize the determined anomaly data into one or more groups of anomaly data based at least on a number of clusters, using at least a supervised or unsupervised model. In some embodiments, the server 106 may be configured to assign a weight to each of the one or more groups of anomaly data. In some embodiments, the server 106 may be configured to determine whether the weight assigned to each of the one or more groups is above a preset threshold value. The preset threshold value corresponds to a minimum value above which an anomaly is detected. In some embodiments, the server 106 may be configured to generate an alert associated with each of the one or more groups, for a user upon determining the weight assigned to each of the one or more groups is above the preset threshold value. The alert associated with each of the one or more groups may correspond to one or more anomalous events detected within the industrial control network 104.

In some embodiments, the server 106 may further be configured to send the alert to the user device 108. The user device 108 may be equipped by an operator, manager of the industrial control network 104, or other service professionals responsible for monitoring and operating the industrial control network 104. In some embodiments, the alert may provide a summarized data to the user to understand the one or more anomalous events detected within the industrial control network 104 and to take an action based on the generated alert. In some embodiments, the user device 108 may include personal computers such as desktop computers, laptop computers, tablets, smartphones, or mobile devices.

It will be apparent to one skilled in the art that above-mentioned components of the system 100 have been provided only for illustration purposes, without departing from the scope of the disclosure.

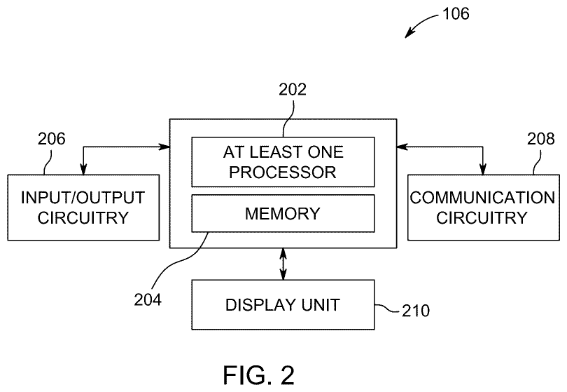

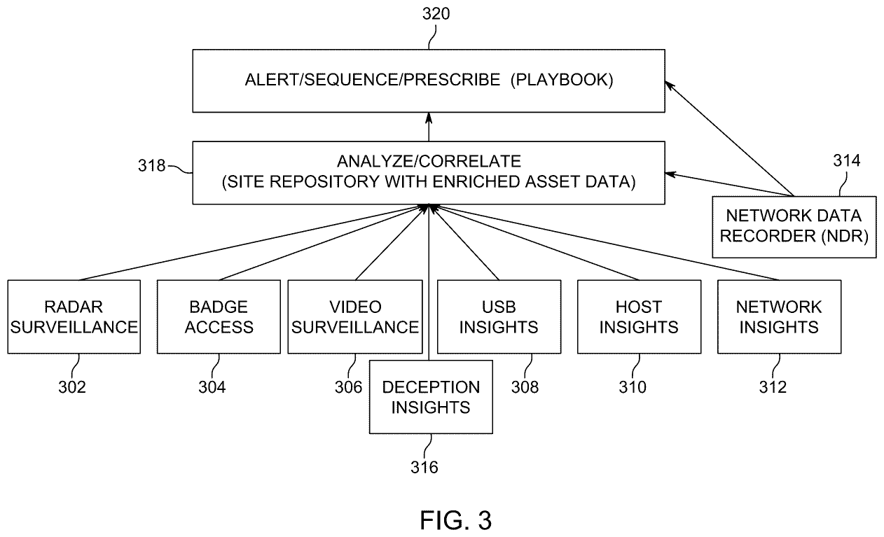

FIG. 2 illustrates a block diagram of the server 106, in accordance with an example embodiment of the present disclosure. FIG. 3 illustrates an overview of the system 100 for detecting anomalies within the industrial control network 104, in accordance with an example embodiment of the present disclosure. FIGS. 2-3 are described in conjunction with FIG. 1.

In some embodiments, the server 106 may comprise at least one processor 202, a memory 204, an input/output circuitry 206, a communication circuitry 208, and a display unit 210. In some embodiments, the at least one processor 202 may be configured to receive the asset data from the one or more assets 110 of the industrial control network 104 in the real time. In some embodiments, the asset data may comprise at least one of identification data, configuration data, operational data, health and diagnostics data, time data, or location data associated with the one or more assets 110. In some embodiments, the one or more assets 110 may comprise at least one of a radar surveillance 302, a badge access 304, a video surveillance 306, USB insights 308, host insights 310, network insights 312, a network data recorder (NDR) 314, and deception insights 316, as illustrated in FIG. 3.

In some embodiments, each of the one or more assets 110 may encompass identification data, which includes unique identifiers or serial numbers assigned to each radar unit. Further, the configuration data may outline settings such as scanning frequency, detection thresholds, and operational modes. Further, the operational data may capture information on detected targets, tracking trajectories, and system uptime. The health and diagnostics data may monitor overall health of radar components, detecting any anomalies or malfunctions. The time data may record timestamps for each detection event and provide temporal context. The location data specifies geographical coordinates or deployment sites of radar units.

In one example embodiment, the radar surveillance 302 may be configured to monitor and provide safety and security to the industrial control network 104. The radar surveillance 302 may use radio waves to detect and track objects within a field of view and provide real-time situational awareness to security personnel. For instance, in an oil refinery, the radar surveillance 302 may detect unauthorized vehicles or individuals approaching restricted areas, and thus may allow security teams to respond promptly and mitigate potential threats.

In another example embodiment, the badge access 304 may be configured to regulate physical access within the industrial control network 104. The badge access 304 control systems may use electronic badges or keycards to authenticate individuals and grant or deny access based on predefined permissions. For example, in a chemical plant, the badge access 304 control systems may ensure that only authorized personnel with necessary training and credentials can enter areas containing hazardous materials or equipment, thereby enhancing safety and security measures. Further, the asset data for the badge access 304 may include identification data, such as employee or user IDs and access card numbers. The configuration data may define access permissions, clearance levels, and credential settings for users. The operational data may access events in the real time, including entry/exit times and access points utilized. The operational data may record footage and camera status. The health and diagnostics data may monitor hardware functionality, detecting card reader, or door lock issues. The health and diagnostics data may monitor camera health and functionality. The time data may correspond to timestamp of recorded footage, and location data may indicate physical placement of each camera for coverage assessment.

In some embodiments, the video surveillance 306 may provide visual monitoring and recording of activities within the industrial control network 104. In the video surveillance 306, video cameras may be placed strategically throughout premises to capture footages in the real time. The video cameras may allow to monitor operations, investigate incidents, and review footage for forensic analysis. In one example, in a manufacturing plant, the video surveillance 306 may be configured to identify equipment malfunctions, detect safety violations, and deter unauthorized access or theft, thereby safeguarding assets and ensuring compliance with regulatory requirements. In some embodiments, the asset data for the video surveillance 306 may comprise, but is not limited to, identification data for each camera, configuration data specifying recording settings, and camera angles.

In some embodiments, the USB insights 308 may be defined as critical assets that monitors and controls the use of USB devices within the industrial control network 104. The USB insights 308 may analyze USB activity, including device insertion, file transfers, and data exchanges, to identify potential security risks and enforce policies to prevent unauthorized data exfiltration or malware infections. In one example, in a power generation facility, the USB insights 308 may be configured to monitor USB ports associated with the industrial control network 104 to detect and block malicious devices or unauthorized data transfers. The asset data for the USB insights 308 may include identification data for each USB device associated with the industrial control network. The configuration data may provide details of permitted or restricted usage policies. The operational data may track USB device connections and data transfers. The health and diagnostics data may monitor USB port functionality and security risks. The time data may record timestamps for each USB activity, and location data may indicate physical location of USB ports.

In some embodiments, the host insights 310 may provide visibility into the security posture and behavior of endpoint devices associated with the industrial control network 104. The host insights 310 may continuously monitor endpoints for signs of suspicious activity, malware infections, or policy violations, allowing operators to take proactive measures to mitigate risks and protect against cyber threats. In one example, in a utility company, tools of the host insights 310 may detect unauthorized software installations on control system computers, to prevent cyber-attacks that may disrupt essential services. The asset data for the host insights 310 may encompass identification data for each host or endpoint device. The configuration data may specify security policies and software configurations. The operational data may track activities and events associated with the endpoint devices. The health and diagnostics data may monitor host's health and performance. The time data may record timestamps for system's events. The location data may indicate the physical location of host devices within the industrial control network 104.

In some embodiments, the network insights 312 may provide visibility into network traffic and behavior, enabling operators to detect anomalies, identify security threats, and optimize network performance. The network insights 312 may use advanced analytics and machine learning algorithms to analyze network traffic patterns, detect deviations from normal behavior, and alert operators to potential security incidents or performance issues. In one example, in a transportation hub, tools of the network insights 312 may monitor network traffic between control systems and sensors to detect unusual communication patterns or unauthorized access attempts, and thus prevents cyber-attacks and ensures the reliability of critical infrastructure. The asset data for the network insights 312 may include identification data for network devices such as routers, switches, and firewalls. The configuration data may provide details of network topology and device settings. The operational data may capture network traffic and status of devices associated with the industrial control network 104. The health and diagnostics data may monitor network's health and performance. The time data may record timestamps for network events, and location data may indicate the physical placement of network devices within the industrial control network 104.

In some embodiments, the NDR 314 may be configured to capture and analyze network traffic for detecting and responding to security threats in the real time. The NDR 314 may passively monitor network traffic, analyze packet payloads, and identify indicators of compromise (IOCs) to detect and mitigate cyber threats such as malware infections, data breaches, or insider threats. In one example, in a manufacturing facility, the NDR 314 may identify suspicious network activity indicative of a cyber-attack on the industrial control network 104, enabling rapid response and containment to minimize potential damage or disruption to operations. The asset data for the NDR 314 may comprise identification data for each network data recorder device. The configuration data may specify data capture parameters and storage settings. The operational data may record network traffic and data analysis results. The health and diagnostics data may monitor device functionality and storage capacity. The time data may record timestamps for captured network packets. The location data may indicate the physical placement of NDR devices within the industrial control network 104.

In some embodiments, the deception insights 316 may employ deception techniques to detect and deceive attackers attempting to infiltrate the industrial control network 104. In some embodiments, tools used in the deception insights 316 may create decoy assets and lure attackers into engaging with them, allowing security teams to monitor and analyze their tactics and techniques. By leveraging the deception insights 316, the industrial control network 104 may gain valuable intelligence about potential threats and improve overall security posture of the industrial control network 104. The asset data for the deception insights 316 may include identification data for each decoy or honeypot deployed within the industrial control network 104. The configuration data may provide details of deception strategies and bait content. The operational data may track interactions with decoy assets and potential intruders. The health and diagnostics data may monitor decoy functionality and security posture. The time data may record timestamps for intrusion attempts and interactions. The location data may indicate the placement of decoy assets within the industrial control network 104 to maximize effectiveness.

In one example, a control room operates with numerous assets, including the radar surveillance 302, the badge access 304, the video surveillance 306, the USB insights 308, the host insights 310, and the NDR 314. Each of these assets generates vast amount of data in the real time, encompassing identification, configuration, operational, health, diagnostics, time, and location data. The at least one processor 202 receives the asset data from the video surveillance 306 that records the face of Robert A along with an enter time of 11:30:07, the face of Bruce P with an enter time of 11:35:07, and the face of Marcelo B along with an enter time of 11:50:10. The room is having a badge access 304 and the badge access 304 indicates a badge in/badge out time for individuals entering/exiting the room. For example, a badge in time of 11:30:10 is indicated for Robert A, a badge out time of 11:33:12 is indicated for Robert A, a badge in time of 11:35:10 is indicated for Bruce P, and a badge in time of 11:50:13 is indicated for Parker C. Further, data of asset activity of individuals is received. For example, a time of 11:53:40 for Asset 3, having a login activity by Parker C.

In some embodiments, the at least one processor 202 may be configured to correlate the asset data received from the one or more assets 110 with the predefined functional data, as illustrated by 318 in FIG. 3. The predefined functional data, i.e., site repository with enriched asset data, may correspond to functionalities of each of the one or more assets 110 and interactions between the one or more assets 110. For example, as the video surveillance 306 records the data, the at least one processor 202 correlates the data with the predefined functional data that reflects the normal behavior and interactions of the one or more assets within the industrial control network 104.

In one example, the asset 3 has a node ID 192.168.2.14 which is a data repository 1. For instance, the video surveillance 306 recorded data is cross-referenced with the badge access 304 logs that indicate a badge in/badge out time, to verify that the right personnel are accessing the control room at the appropriate times. The correlation is performed using a sophisticated data collector, which ensures that all relevant data points are integrated seamlessly. The data is correlated as time: 10:53:40, asset: Asset 3, activity: Login, information: Parker C, asset node ID: 192.168.2.14, asset description: Data Repository 1, badge access 304 insights: Bruce P, Parker C, and video surveillance 306: Robert A, Marcelo B, Bruce P.

Further, the at least one processor 202 may be configured to determine anomaly data within the correlated asset data of the one or more assets 110 based at least on a weight factor and an anomaly score, using an unsupervised model. The anomaly data may correspond to deviation of data from normal or expected behavior of the one or more assets 110 within the industrial control network 104. It may be noted that the anomaly data may indicate potential problems, security breaches, or inefficiencies within the industrial control network 104. In some embodiments, the unsupervised model may be configured to determine patterns and relationships in the correlated asset data and may be configured to cluster the correlated asset data to determine the anomaly data.

In some embodiments, the anomaly data within the correlated asset data of the one or more assets 110 is determined by converting one or more columns of the correlated asset data into a numeric value. The one or more columns may be converted into the numeric value, using a label encoder (not illustrated). In one example, the one or more columns may correspond to, but are not limited to, time, asset, activity, information, asset node ID, asset description, badge access 304 insights, and video surveillance 306 associated with the one or more assets 110. In some embodiments, the label encoder may convert categorical data in the form of the one or more columns within the correlated asset data of the one or more assets into numeric values. the label encoder may assign a unique numeric label to each of the one or more columns, effectively transforming qualitative information into quantitative representations or numeric values. The unique numeric label may enable the unsupervised model to process and analyze the correlated asset data more effectively, facilitating anomaly detection and pattern recognition tasks. By converting the one or more columns into numeric values, the label encoder may enhance the efficiency and accuracy of the anomaly detection process, contributing to an overall effectiveness of the system 100.

In some embodiments, the at least one processor 202 may further be configured to assign the weight factor to each of the one or more columns. The weight factor may be assigned using a random forest technique. Further, the at least one processor 202 may be configured to determine the anomaly score for each correlated asset data based at least on the assigned weight and a predefined threshold value. The anomaly score may indicate a degree of anomaly of the correlated asset data. Thereafter, the at least one processor 202 may be configured to determine the anomaly data within the correlated asset data based at least on the anomaly score. In some embodiments, the random forest technique may distribute the correlated asset data based on the anomaly score and determine entries with extreme situations or anomaly data. For example, the at least one processor 202 assigns weight factors to asset data comprising the login by Parker C and determines an anomaly score that surpasses the predefined threshold value. The combined data from the video surveillance 306, the badge access 304, and the data of asset activity form a comprehensive view of the situation in a control room, which the at least one processor 202 processes to generate structured text alerts for security operation center (SOC) analysts.

In some embodiments, the at least one processor 202 may be configured to categorize the determined anomaly data into one or more groups of anomaly data based at least on a number of clusters, using at least a supervised or unsupervised model. In some embodiments, the at least one processor 202 may be configured to determine the number of the clusters dynamically from the determined anomaly data. The at least one processor 202 may be configured to determine the number of the clusters, using an elbow management technique. The elbow management technique may cluster determined anomaly data into meaningful number of clusters. In some embodiments, upon employing the unsupervised or supervised model for categorization, an appropriate number of clusters may be ascertained to effectively partition the determined anomaly data without underfitting or overfitting. The elbow management technique may assist the at least one processor 202 by analyzing the relationship between the number of clusters and a within-cluster sum of squares (WCSS) or other relevant metrics used in the elbow management technique. It may be noted that utilizing the elbow management technique, the at least one processor 202 may dynamically determine the number of clusters, ensuring that the anomaly data is categorized into coherent and informative groups, thereby enhancing the efficacy of subsequent analysis and decision-making process of the system 100. In some embodiments, the number of clusters are labeled and are used for training the supervised model. In some embodiments, the supervised model is further configured to categorize the determined anomaly data into the one or more groups based on the labeled number of clusters.

For example, anomalies related to “Login Attempts” are grouped together, while those related to “File transfer” are classified separately. The clustering is managed dynamically, ensuring that analysts are not overwhelmed by a flood of individual alerts but can focus on the most significant groups of anomalies. The elbow management technique helps to determine the optimal number of clusters, improving the efficiency of threat hunting and response activities.

In some embodiments, the at least one processor 202 may further be configured to assign a weight to each of the one or more groups of anomaly data. In some embodiments, the at least one processor 202 may be configured to determine whether the weight assigned to each of the one or more groups is above a preset threshold value. The preset threshold value may correspond to a minimum value above which an anomaly is detected. In some embodiments, the at least one processor 202 may be configured to determine anomaly data within a respective group of anomaly data using the unsupervised model upon determining the weight assigned to each of the one or more groups is below the preset threshold value.

In some embodiments, the at least one processor 202 may be configured to generate the alert associated with each of the one or more groups, for a user upon determining the weight assigned to each of the one or more groups is above the preset threshold value, as illustrated by 320 in FIG. 3. The alert i.e., the alert/sequence/prescribe (playbook), associated with each of the one or more groups may correspond to one or more anomalous events detected within the industrial control network 104. In some embodiments, the at least one processor 202 may be configured to send the alert to the user for taking an action. The action may be taken in response to the one or more anomalous events detected within the industrial control network 104.

In one example, the control room's network data recorder detects unusual “file transfer” patterns that coincide with a USB device being inserted into a control system. The anomaly score for this event is calculated as “23”, and since it exceeds the preset threshold i.e., “16”, an alert is generated and sent to the SOC analysts. The alert includes detailed information on the anomaly, such as the time, asset node ID, and associated activities. This enables the SOC analysts to swiftly investigate the root cause and mitigate any potential security threats or operational disruptions. For example, the alert includes that Marcelo B has badged in as Parker C and worked with Bruce P to intentionally inject malware into the OT environment. Further, the alert is sent to the user for taking an action is response to Marcelo B injecting malware into the OT environment.

In some embodiments, the NDR 314 may capture and analyze network traffic to detect and respond to security threats in the real time, when the asset data is correlated or analyzed at 318 and when the alert/sequence/prescribe is generated at 320. The NDR 314 may passively monitor network traffic, analyze packet payloads, and indicators of compromise (IOCs) to detect and mitigate cyber threats such as malware infections, data breaches, or insider threats, when the asset data is correlated or analyzed at 318 and when the alert is generated at 320.

The at least one processor 202 may include suitable logic, circuitry, and/or interfaces that are operable to execute one or more instructions stored in the memory 204 to perform predetermined operations. In one embodiment, the at least one processor 202 may be configured to decode and execute any instructions received from one or more other electronic devices or server(s). The at least one processor 202 may be configured to execute one or more computer-readable program instructions, such as program instructions to carry out any of the functions described in this description. Examples of the at least one processor 202 may include, but are not limited to, one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor).

In some embodiments, the memory 204 may be configured to store a set of instructions and data executed by the at least one processor 202. Further, the memory 204 may include the one or more instructions that are executable by the at least one processor 202 to perform specific operations. The memory 204 may be configured to include the instructions to receive the asset data from the one or more assets 110 of the industrial control network 104 in the real time. The memory 204 may be configured to include the instructions to correlate the asset data received from the one or more assets 110 with the predefined functional data. Further, the memory 204 may be configured to include the instructions to determine anomaly data within the correlated asset data of the one or more assets 110 based on the weight factor and the anomaly score, using the unsupervised model. The memory 204 may be configured to include the instructions to categorize the determined anomaly data into one or more groups of anomaly data based at least on the number of clusters, using at least the supervised or unsupervised model.

Furthermore, the memory 204 may be configured to include the instructions to assign the weight to each of the one or more groups of the anomaly data. The memory 204 may be configured to include the instructions to determine whether the weight assigned to each of the one or more groups is above the preset threshold value. The memory 204 may be configured to include the instructions to generate the alert associated with each of the one or more groups, for the user upon determining the weight assigned to each of the one or more groups is above the preset threshold value. It is apparent to a person with ordinary skill in the art that the one or more instructions stored in the memory 204 enable the hardware of the server 106 to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

In some embodiments, the server 106 may further comprise the input/output circuitry 206. The input/output circuitry 206 may enable a user to communicate or interface with the server 106, via the user device 108. The user device 108 may include N number of user devices. In some embodiments, the input/output circuitry 206 may act as a medium to transmit input from the interface to and from the server 106. In some embodiments, the input/output circuitry 206 may refer to the hardware and software components that facilitate the exchange of information between user device 108 and the server 106. In one example, the user device 108 may include a graphical user interface (GUI) (not shown) as an input circuitry to allow the one or more users to search the one or more assets 110. The input/output circuitry 206 may include various input devices such as keyboards, barcode scanners, GUI for the one or more users to provide data and various output devices such as displays, printers for the one or more users to receive data. In another example, the input/output circuitry 206 may include various output circuitry such as a display to show the generated alert.

In some embodiments, the server 106 may further comprise the communication circuitry 208. The communication circuitry 208 may allow the server 106 to exchange data or information with other systems or apparatuses. Further, the communication circuitry 208 may include network interfaces, protocols, and software modules responsible for sending and receiving data or information. In some embodiments, the communication circuitry 208 may include Ethernet ports, Wi-Fi adapters, or communication protocols like HTTP or MQTT for connecting with other systems. The communication circuitry 208 may further include components such as communication modules (e.g., Wi-Fi, Ethernet, cellular), transceivers, antennas, and protocols (e.g., TCP/IP, MQTT, SNMP) for exchanging data with other systems or network devices. The communication circuitry 208 may allow the server 106 to stay up-to-date and accurately track the one or more assets 110 of the industrial control network 104.

In some embodiments, the server 106 may further comprise the display unit 210. The at least one processor 202 may be configured to send the alert to the user on the display unit 210. The alert may be sent on the display unit 210 for taking the action in response to the one or more anomalous events detected within the industrial control network 104. In some embodiments, the display unit 210 may further include a smartphone, a tablet, a laptop, a personal computer (PC), a smart watch or any other computing device having the display unit 210 known in the art. In one embodiment, the user may use the smartphone or the tablet as a device to receive the generated alert on the display unit 210. In another embodiment, a dedicated Android or iOS application may be developed to interact with the industrial control network 104, via the display unit 210.

It will be apparent to one skilled in the art the above-mentioned components of the server 106 have been provided only for illustration purposes, without departing from the scope of the disclosure.

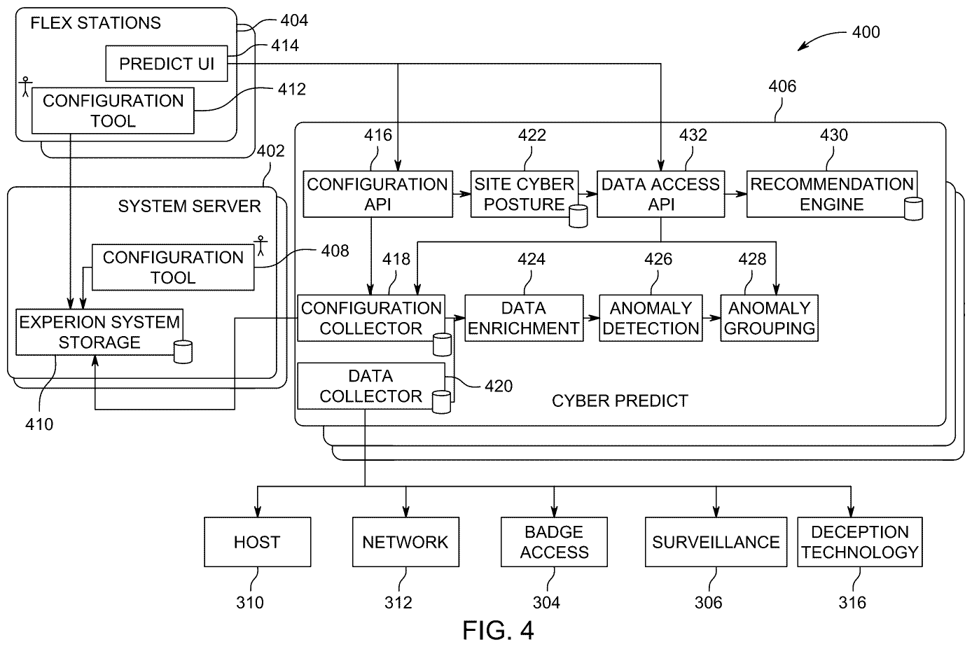

FIG. 4 illustrates a detailed block diagram 400 of the system 100 for detecting anomalies within the industrial control network 104, in accordance with an example embodiment of the present disclosure.

In some embodiments, the block diagram 400 may address functional capabilities of the system 100, external interfaces of the system 100, and the system 100 partitioning into major functional subsystems. In some embodiments, the block diagram 400 may provide a structural view of the functional capabilities of the system 100 and the way the functional capabilities are partitioned between major functional subsystems.

In some embodiments, the block diagram 400 may comprise a system server 402, flex stations 404, and a cyber predict 406. The system server 402 may comprise a configuration tool 408 and an experion system storage 410. The flex stations 404 may comprise a configuration tool 412 and a predict user interface (UI) 414. The cyber predict 406 may comprise a configuration application programming interface (API) 416, a configuration collector 418, a data collector 420, a site cyber posture 422, a data enrichment 424, an anomaly detection 426, an anomaly grouping 428, a recommendation engine 430, and a data access application programming interface (API) 432.

In some embodiments, the system server 402 may correspond to a location where a control definition is stored for an OT system. In some embodiments, the configuration tool 408 may be configured to store the control definition. In some embodiments, the experion system storage 410 may be configured to show the location of control tags for other systems connected to the system 100. In some embodiments, the flex stations 404 may be a node at which user interacts with the configuration tool 412 and the predict UI 414 for the cyber predict 406. In one example, the predict UI 414 may be browser-based. In some embodiments, the cyber predict 406 may be configured to handle a large amount of traffic ingestion, analysis, correlation, and recommendation for the system 100 to anticipate and mitigate cyber threats within the industrial control network 104.

In some embodiments, the configuration API 416 may correspond to a read/write API provided by the cyber predict 406 to allow the user to upload definition of the system 100, manually. The configuration API 416 may streamline the process of system's configuration and customization, fostering agility and adaptability within framework of the cyber predict 406 by providing a standardized mechanism for data exchange. The user may leverage the configuration API 416 to manually input system's parameters, configurations, or bespoke cybersecurity solutions, thereby ensuring alignment with security mandates.

In some embodiments, the configuration collector 418 may correspond to a component that is responsible to collect and store a system's definition for the cyber predict 406. In one example embodiment, the system's definition may refer to clearly outlining boundaries, components, functions, and interactions of the system 100 over the network 102. The configuration collector 418 may comprise a persistent storage configuration of the system 100 where relevant control tags are stored. The configuration collector 418 may include the asset data from asset management solution or the one or more assets 110. In some embodiments, the data collector 420 may correspond to a common component that retrieves the asset data from the one or more assets 110 or cyber solutions deployed on site.

The data collector 420 may retrieve the asset data from the host insights 310, i.e., hosts, the network insights 312, i.e., network, the badge access 304, the video surveillance 306, i.e., surveillance, and the deception insights 316, i.e., deception technology. The data collector 420 may be configured to integrate with other one or more assets 110 or solutions and store the asset data locally for a certain period before discarding the asset data. The asset data may be stored in unstructured format as the asset data is in different format due to variety of the one or more assets 110 or solutions.

In some embodiments, the site cyber posture 422 may correspond to a data store for storing solutions that users require to be deployed on site, where the system 100 is to be installed. The site cyber posture 422 may be provided with a template by default that can be overridden by the users provided one or more assets 110 or solution deployments. As a result, the cyber predict 406 may provide a status of connectivity to the different one or more assets 110 or solutions available. In some embodiments, the data enrichment 424 may obtain data from the configuration collector 418 and the data collector 420. The data from the configuration collector 418 and the data collector 420 may be correlated to generate a structured text that is fed to the anomaly detection 426. The structured text may comprise the correlated asset data received from the one or more assets 110 with the predefined functional data, as described in FIG. 2.

In some embodiments, the anomaly detection 426 may correspond to a non-rule and non-signature-based anomaly detection engine that is configured to identify anomalies from the correlated data passing through in a batched format. In some embodiments, the anomaly grouping 428 may group multiple anomalies against similar looking anomalies to reduce threat hunting abilities, for situations where the anomaly detection 426 generates multiple anomalies.

In some embodiments, the recommendation engine 430 may generate a live playbook based on the one or more anomalous events detected. Once the one or more anomalous events are detected, the recommendation engine 430 may utilize sophisticated algorithms and contextual insights to craft a tailored response strategy. By correlating the one or more anomalous events with predefined playbooks or procedural guidelines, the recommendation engine 430 may formulate actionable recommendations aimed at mitigating potential risks or vulnerabilities. Further, the recommendations may not be static but are dynamically generated in real-time, allowing for swift adaptation to evolving threat landscapes and operational exigencies based on the one or more anomalous events.

In some embodiments, the data access API 432 may be configured to allow the user to get the asset data from the one or more assets or get anomaly data, add the asset data within the memory 204, update the asset data within the memory 204, and delete the asset data from the memory 204. The asset data and the anomaly data managed by the data access API 432 may empower the user to interact with the predict UI 414 in a meaningful and informed manner, providing the user with real-time insights into potential cybersecurity threats and anomalous events. By feeding the predict UI 414 with a holistic view of an operational landscape of the system 100, the data access API 432 may enable the user to make informed decisions and take proactive measures to mitigate risks effectively. Further, by ensuring that the predict UI 414 reflects the latest information, including generated alerts, user may respond promptly to emerging threats, bolstering the overall resilience and security posture. Thus, the data access API 432 may serve as a critical conduit for delivering actionable intelligence to users, enhancing situational awareness, and empowering proactive cybersecurity defense strategies.

It will be apparent to one skilled in the art the above-mentioned components of the block diagram 400 of the system 100 have been provided only for illustration purposes, without departing from the scope of the disclosure.

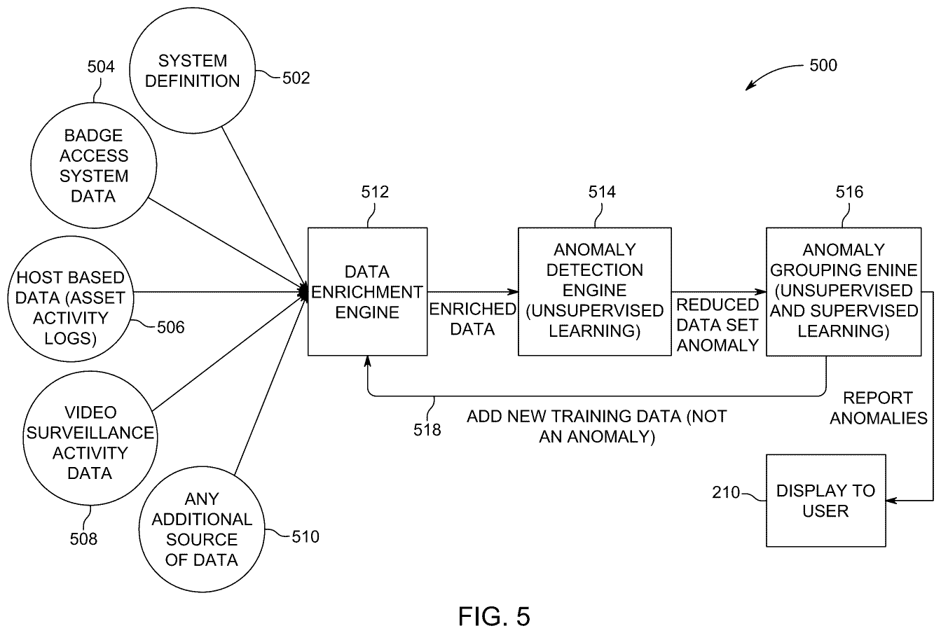

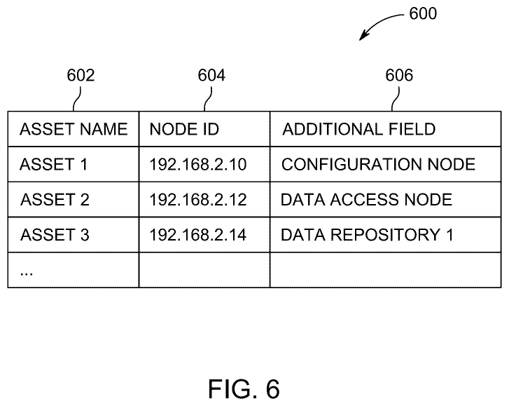

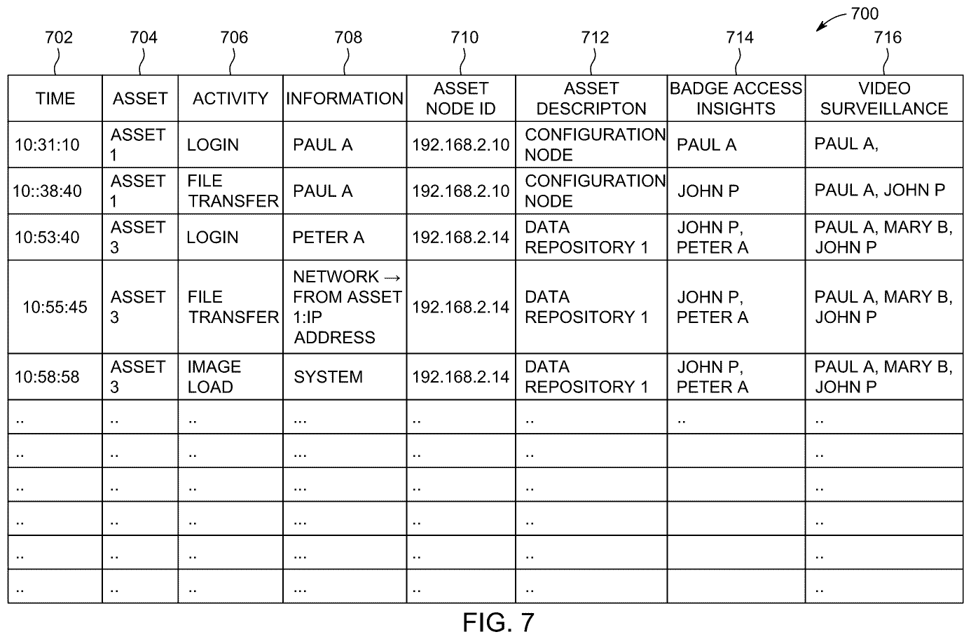

FIG. 5 illustrates a block diagram 500 showing flow of the asset data usage within the system 100 for detecting anomalies within the industrial control network 104, in accordance with an example embodiment of the present disclosure. FIG. 6 illustrates a database 600 of the predefined functional data, in accordance with an example embodiment of the present disclosure. FIG. 7 illustrates a database 700 of the correlated asset data, in accordance with an example embodiment of the present disclosure. FIGS. 5-7 are described in conjunction with FIGS. 1-4.

As described above in FIG. 2, the at least one processor 202 may be configured to receive the asset data from one or more assets 110 of the industrial control network 104 in the real time. The asset data may be received using the data collector 420. The asset data may comprise, but is not limited to, a system definition 502, a badge access system data 504 from the badge access 304, a host based data 506, having asset activity logs, from the host insights 310, a video surveillance activity data 508 from the video surveillance 306, and any additional source of data 510 such as radar surveillance 302, USB insights 308, network insights 312, or NDR 314. In some embodiments, the asset data comprising the system definition 502, the badge access system data 504, the host based data 506, the video surveillance activity data 508, and any additional source of data 510 may be derived from each of the asset data comprising identification data, configuration data, operational data, health and diagnostics data, time data, or location data associated with the one or more assets, or in any combination of the asset data.

For example, a control room operates with numerous assets, including radar surveillance 302, badge access systems, video surveillance 306, USB insights 308, host insights 310, and NDR 314. Each of these assets generates vast amount of data in real time, encompassing identification, configuration, operational, health, diagnostics, time, and location data. The at least one processor 202 receives the asset data from a video surveillance 306 that records the face of Paul A along with an enter time of 10:30:07, the face of John P with an enter time of 10:35:07, and the face of Mary B along with an enter time of 10:50:10. The room is badged and indicates a badge in/badge out time for individuals. For example, a badge in time of 10:30:10 is indicated for Paul A, a badge out time of 10:33:12 is indicated for Paul A, a badge in time of 10:35:10 is indicated for John P, and a badge in time of 10:50:13 is indicated for Peter A. Further, data of asset activity of users is received. For example, a time of 10:53:40 for Asset 3, having a login activity by Peter A.

Further, the at least one processor 202 may be configured to correlate the asset data that is received from the one or more assets 110 with the predefined functional data. In some embodiments, a data enrichment engine 512 may receive the asset data from the data collector 420. The asset data may be correlated to generate a structured text, i.e., enriched data, that is fed to an anomaly detection engine 514. The structured text may comprise the correlated asset data received from the one or more assets 110 with the predefined functional data, as illustrated in the database 600 in FIG. 6. The database 600 may comprise an asset name 602, a node ID 604, and an additional field 606. In some embodiments, the asset name 602 may serve as a unique identifier for each asset data in the database 600. The asset name 602 may allow for easy referencing and retrieval of information related to specific assets. The asset name 602 may provide context and helps to maintain the integrity of the data within the database 600 by associating each piece of information with a respective source.

In some embodiments, the node ID 604 may serve as a reference to the specific node or location associated with the asset name 602. In the system 100, where the one or more assets 100 are distributed across different nodes or locations, the node ID 604 helps to organize and categorize the asset data based on origin of the asset data. The categorization may be crucial for analyzing and managing assets efficiently, especially in the system 100 where the one or more assets 110 may be spread across diverse environments. The node ID 604 may comprise IP address of the one or more assets 110 or MAC address of the one or more assets 110 or both. Additionally, the database 600 may include the additional field 606. The additional field 606 may serve as a flexible space for storing additional relevant asset data associated with the one or more assets 110. The additional field 606 may accommodate various types of information depending on the specific needs of the system 100 or the nature of the one or more assets 110 being monitored. Inclusion of the additional field 606 may provide versatility and adaptability to the structure of the database 600, allowing for the incorporation of new data types or attributes as required in the system 100.

In one example, the database 600 may comprise the asset name 602 as “asset 1” that has the node ID 604 as “192.168.2.10” having the additional field 606 that describes the asset 1 as “configuration node”. In another example, the database 600 may comprise the asset name 602 as “asset 2” that has the node ID 604 as “192.168.2.12” having the additional field 606 that describes the asset 2 as “data access node”. In yet another example, the database 600 may comprise the asset name 602 as “asset 3” that has the node ID 604 as “192.168.2.14” having the additional field 606 that describes the asset 1 as “data repository 1”.

After the correlation, the at least one processor 202 may be configured to determine anomaly data within the correlated asset data of the one or more assets 110, i.e., enriched data, based on the weight factor and anomaly score. The at least one processor 202 may be configured to determine anomaly data within the correlated asset data, using the unsupervised model, i.e., unsupervised learning. In some embodiments, the anomaly detection engine 514 may help to identify anomalies, i.e., anomaly data, from the correlated asset data that is passing through in a batched format. In some embodiments, the at least one processor 202 may be configured to convert one or more columns of the correlated asset data into the numeric value, using the label encoder. The one or more columns may comprise, but are not limited to, a time 702, an asset 704, an activity 706, information 708, an asset node ID 710, an asset description 712, a badge access 304 insights 714, and a video surveillance 716, as illustrated in the database 700 of FIG. 7. In some embodiments, the time 702 within the database 700 may serves as a temporal reference point for the correlated asset data, indicating the occurrence or timing of specific events or activities associated with the one or more assets 110. The temporal reference point may be crucial for analyzing patterns, trends, and anomalies over time, enabling effective monitoring and management of asset-related activities.

In some embodiments, the asset 704 may act as a unique identifier for each asset included in the database 700, facilitating the tracking and management of individual assets throughout the system 100. The activity 706 may describe specific actions or operations performed by the one or more assets 110, providing insight into the behavior and functionality of the one or more assets 110. The information 708 may encompass additional details or metadata associated with the asset data, providing context and enhancing the understanding of the recorded information. The asset node ID 710 may denote the specific node or location associated with each asset, aiding in the spatial organization and management of the one or more assets 110 within the system 100.

In some embodiments, the asset description 712 may provide a textual description or characterization of each asset, offering additional information about the type, purpose, or specifications. The badge access insights 714 may capture data related to badge access events, such as entry or exit times, providing security-related insights and enabling access control monitoring. The badge access insights 714 may provide information about the people in control room. The video surveillance 716 of the database 700 may store information related to video footage or recordings associated with the one or more assets 110, facilitating visual monitoring and surveillance activities. The video surveillance 716 may provide information about the people visited since shift.

In one example embodiment, the database 700 may comprise the time 702 as “10:31:10”, the asset 704 as “Asset 1”, the activity 706 as “Login”, the information 708 as “Paul A”, the asset node ID 710 as “192.168.2.10”, the asset description 712 as “Configuration Node”, the badge access insights 714 as “Paul A”, and the video surveillance 716 as “Paul A”. In another example embodiment, the database 700 may comprise the time 702 as “10:38:40”, the asset 704 as “Asset 1”, the activity 706 as “File transfer”, the information 708 as “Paul A”, the asset node ID 710 as “192.168.2.10”, the asset description 712 as “Configuration Node”, the badge access insights 714 as “John P”, and the video surveillance 716 as “Paul A, John P”.

In yet another example embodiment, the database 700 may comprise the time 702 as “10:53:40”, the asset 704 as “Asset 3”, the activity 706 as “Login”, the information 708 as “Peter A”, the asset node ID 710 as “192.168.2.14”, the asset description 712 as “Data Repository 1”, the badge access insights 714 as “John P, Peter A”, and the video surveillance 716 as “Paul A, Mary B, John P”. In another example embodiment, the database 700 may comprise the time 702 as “10:55:45”, the asset 704 as “Asset 3”, the activity 706 as “File transfer”, the information 708 as “Network-> from asset 1: IP address”, the asset node ID 710 as “192.168.2.14”, the asset description 712 as “Data Repository 1”, the badge access insights 714 as “John P, Peter A”, and the video surveillance 716 as “Paul A, Mary B, John P”. In yet another example embodiment, the database 700 may comprise the time 702 as “10:58:58”, the asset 704 as “Asset 3”, the activity 706 as “Image Load”, the information 708 as “system”, the asset node ID 710 as “192.168.2.14”, the asset description 712 as “Data Repository 1”, the badge access insights 714 as “John P, Peter A”, and the video surveillance 716 as “Paul A, Mary B, John P”.

Then, the at least one processor 202 may be configured to assign the weight factor to each of the one or more columns, using the random forest technique. After assigning the weight factor, the at least one processor 202 may be configured to determine the anomaly score for each correlated asset data that is based at least on the assigned weight and the predefined threshold value. Herein, the anomaly score may indicate a degree of anomaly of the correlated asset data. Thereafter, the at least one processor 202 may be configured to determine the anomaly data within the correlated asset data that is based on the anomaly score, i.e., reduced data set anomaly.

For example, the at least one processor 202 assigns weight factors to asset data comprising the login by Peter A and determines an anomaly score that surpasses the predefined threshold value. The combined data from the video surveillance 306, the badge access 304, and the data of asset activity forms a comprehensive view of the situation in the control room, which the anomaly detection engine 514 processes to generate structured text alerts for SOC analysts.

Upon the determination of the anomaly data, the at least one processor 202 may be configured to categorize the determined anomaly data into one or more groups of anomaly data. The determined anomaly data may be categorized based at least on the number of clusters, using at least the supervised or unsupervised model, i.e., supervised or unsupervised learning. In one example embodiment, the unsupervised model may correspond to a non-labeled k-means clustering algorithm. For situations where the anomaly detection engine 514 may generate multiple anomalies, the multiple anomalies need to be grouped against similar looking anomalies to reduce the threat hunting abilities.

In some embodiments, an anomaly grouping engine 516 may group multiple anomalies against similar looking anomalies to reduce the threat hunting abilities, using at least the unsupervised or supervised learning i.e., model. The at least one processor 202 may be configured to determine the number of the clusters dynamically from the determined anomaly data, using the elbow management technique. For example, anomalies related to “Login Attempts” are grouped together, while those related to “File transfer” are classified separately. The clustering is managed dynamically, ensuring that SOC analysts are not overwhelmed by a flood of individual alerts but can focus on the most significant groups of anomalies. The elbow management technique helps determine the optimal number of clusters, improving the efficiency of threat hunting and response activities. In some embodiments, the at least one processor may be configured to add new training data which is not an anomaly data or data isolated when grouping multiple anomalies, to the data enrichment engine 512 as shown by 518.

Further, the at least one processor 202 may be configured to assign the weight to each of the one or more groups of anomaly data. After assigning the weights, the at least one processor 202 may be configured to determine whether the weight assigned to each of the one or more groups is above the preset threshold value. The preset threshold value may correspond to the minimum value above which the anomaly is detected. Alternatively, the at least one processor 202 may be configured to determine anomaly data within the respective group of anomaly data using the unsupervised model upon determining the weight assigned to each of the one or more groups is below the preset threshold value. Thereafter, the at least one processor 202 may be configured to generate the alert associated with each of the one or more groups, for the user. The alert may be generated upon determining that the weight assigned to each of the one or more groups is above the preset threshold value. The alert associated with each of the one or more groups may comprise one or more anomalous events detected within the industrial control network 104. The at least one processor 202 may be configured to send the generated alert to the user, i.e., report anomalies, for taking an action is response to the one or more anomalous events detected within the industrial control network 104. The at least one processor 202 may display the generated alert to the user, on the display unit 210, for further interpretation.

For example, the control room's network data recorder detects unusual “file transfer” patterns that coincide with a USB device being inserted into a control system. The anomaly score for this event is calculated as “20”, and since it exceeds the preset threshold i.e., “15”, an alert is generated and sent to the SOC analysts. The alert includes detailed information on the anomaly, such as the time, asset node ID, and associated activities. This enables the SOC analysts to swiftly investigate the root cause and mitigate any potential security threats or operational disruptions. The alert includes that Mary B has badged in as Peter A and worked with John P to intentionally inject malware into the OT environment. And, the alert is sent to the user for taking an action is response to Mary B injecting malware into the OT environment.

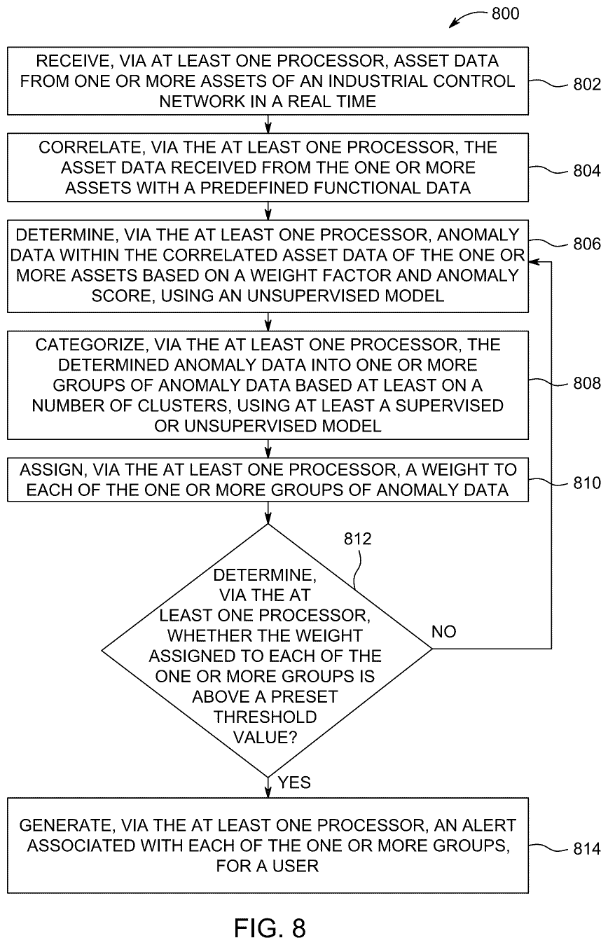

FIG. 8 illustrates a flowchart showing a method 800 for detecting anomalies within the industrial control network 104, in accordance with an example embodiment of the present disclosure. FIG. 8 is described in conjunction with FIGS. 1-7.

At operation 802, the at least one processor 202 may be configured to receive the asset data from the one or more assets 110 of the industrial control network 104 in the real time. The asset data may comprise at least the identification data, the configuration data, the operational data, the health and diagnostics data, the time data, or the location data associated with the one or more assets 110. The one or more assets 110 may comprise at least one of the radar surveillance 302, the badge access 304, the video surveillance 306, the USB insights 308, the host insights 310, the network insights 312, or the NDR 314.

For example, a control room operates with numerous assets, including radar surveillance 302, badge access systems, video surveillance 306, USB insights 308, host insights 310, and network data recorders (NDR 314). Each of these assets generates vast amount of data in the real time, encompassing identification, configuration, operational, health, diagnostics, time, and location data. The at least one processor 202 receives the asset data from a video surveillance 306 that records the face of Paul A along with an enter time of 10:30:07, the face of John P with an enter time of 10:35:07, and the face of Mary B along with an enter time of 10:50:10. The room is badged and indicate a badge in/badge out time for individuals. For example, a badge in time of 10:30:10 is indicated for Paul A, a badge out time of 10:33:12 is indicated for Paul A, a badge in time of 10:35:10 is indicated for John P, and a badge in time of 10:50:13 is indicated for Peter A. Further, data of asset activity of individuals is received. For example, a time of 10:53:40 for Asset 3, having a login activity by Peter A.

At operation 804, the at least one processor 202 may be configured to correlate the asset data received from the one or more assets 110 with the predefined functional data. The predefined functional data may correspond to the functionalities of each of the one or more assets 110 and interactions between the one or more assets 110. For example, as the video surveillance 306 recorded data is collected, the at least one processor 202 correlates the data with predefined functional data that reflects the normal behaviors and interactions of the facility's assets. For instance, the asset 3 has a node ID 192.168.2.14 which is a data repository 1. For instance, the video surveillance 306 recorded data are cross-referenced with the badge access 304 logs that indicate a badge in/badge out time, to verify that the right personnel are accessing the control room at the appropriate times. The correlation is performed using the data collector 420, which ensures that all relevant data points are integrated seamlessly. The data is correlated as time: 10:53:40, asset: Asset 3, activity: Login, information: Peter A, asset node ID: 192.168.2.14, asset description: Data Repository 1, badge access 304 insights: John P, Peter A, and video surveillance 306: Paul A, Mary B, John P.

At operation 806, the at least one processor 202 may be configured to determine the anomaly data within the correlated asset data of the one or more assets 110 based on the weight factor and anomaly score, using the unsupervised model. The anomaly data may correspond to deviation of data from normal or expected behavior of the one or more assets 110 within the industrial control network 104 indicating potential problems, security breaches, or inefficiencies within the industrial control network 104.

In some embodiments, determining the anomaly data within the correlated asset data of the one or more assets 110 using the unsupervised model may further comprise converting, via the at least one processor 202, one or more columns of the correlated asset data into the numeric value, using the label encoder. In one example embodiment, the one or more columns may correspond to, but are not limited to, time, asset, activity, information, asset node ID, asset description, badge access 304 insights, and video surveillance 306 associated with the one or more assets 110. Further, determining the anomaly data may comprise assigning, via the at least one processor 202, the weight factor to each of the one or more columns, using the random forest technique. Furthermore, determining the anomaly data may comprise determining, via the at least one processor 202, the anomaly score for each correlated asset data based at least on the assigned weight and the predefined threshold value. The anomaly score may indicate the degree of anomaly of the correlated asset data. Thereafter, determining the anomaly data may comprise determining, via the at least one processor 202, the anomaly data within the correlated asset data based at least on the anomaly score.

For example, the at least one processor 202 assigns weight factors to the login by Peter A and determines an anomaly score that surpasses the predefined threshold value. The combined data from the video surveillance 306, the badge access 304, and the data of asset activity forms a comprehensive view of the situation in the control room, which the anomaly detection engine 514 processes to generate structured text alerts for SOC analysts.

At operation 808, the at least one processor 202 may be configured to categorize the determined anomaly data into the one or more groups of anomaly data based at least on a number of clusters, using at least the supervised or unsupervised model. In some embodiments, the method may further comprise determining, via the at least one processor 202, the number of the clusters dynamically from the determined anomaly data, using the elbow management technique. For example, anomalies related to “Login Attempts” are grouped together, while those related to “File transfer” are classified separately. The clustering is managed dynamically, ensuring that analysts are not overwhelmed by a flood of individual alerts but can focus on the most significant groups of anomalies. The elbow management technique helps determine the optimal number of clusters, improving the efficiency of threat hunting and response activities.

At operation 810, the at least one processor 202 may be configured to assign the weight to each of the one or more groups of anomaly data. At operation 812, the at least one processor 202 may be configured to determine whether the weight assigned to each of the one or more groups is above the preset threshold value. The preset threshold value may correspond to a minimum value above which an anomaly is detected. In one case, when the weight assigned is below the preset threshold value, the method may be directed to the operation 806 in which the at least one processor 202 may determine anomaly data within the respective group of anomaly data using the unsupervised model, upon determining the weight assigned to each of the one or more groups is below the preset threshold value. In another case, when the weight assigned is above the preset threshold value, the at least one processor 202 may be configured to generate the alert associated with each of the one or more groups, for the user upon determining the weight assigned to each of the one or more groups is above the preset threshold value, at operation 814. The alert associated with each of the one or more groups may correspond to one or more anomalous events detected within the industrial control network 104.

For example, the control room's network data recorder detects unusual “file transfer” patterns that coincide with a USB device being inserted into a control system. The anomaly score for this event is calculated as “20”, and since it exceeds the preset threshold i.e., “15”, an alert is generated and sent to the SOC analysts. The alert includes detailed information on the anomaly, such as the time, asset node ID, and associated activities. This enables the analysts to swiftly investigate the root cause and mitigate any potential security threats or operational disruptions. For example, the alert includes that Mary B has badged in as Peter A and worked with John P to intentionally inject malware into the OT environment.

In some embodiments, the method may further comprise sending, via the at least one processor 202, the alert to the user for taking an action in response to the one or more anomalous events detected within the industrial control network 104. For example, the alert is sent to the user for taking an action is response to Mary B injecting malware into the OT environment.

By integrating and correlating data from both cyber and physical systems, the method may enhance the control room's ability to detect and respond to complex threats. SOC analysts may quickly perform root cause analysis, predict malicious activities, and identify traces left by intruders. Not only the overall security posture of the industrial control network 104 is improved but also the control room operates efficiently and safely is ensured. The advanced integration of cyber-physical data represents a transformative approach to managing industrial security and operational integrity.

In an exemplary embodiment, a non-transitory machine-readable information storage medium is disclosed. The non-transitory machine-readable information storage medium comprising one or more instructions which when executed by at least one processor 202 may cause the at least one processor 202 to receive the asset data from the one or more assets 110 of the industrial control network 104 in the real time. The asset data may comprise at least the identification data, the configuration data, the operational data, the health and diagnostics data, the time data, or the location data associated with the one or more assets 110. The one or more assets 110 may comprise at least one of the radar surveillance 302, the badge access 304, the video surveillance 306, the USB insights 308, the host insights 310, the network insights 312, or the NDR 314.

In some embodiments, the one or more instructions which when executed by at least one processor 202 may cause the at least one processor 202 to correlate the asset data received from the one or more assets 110 with the predefined functional data. The predefined functional data may correspond to functionalities of each of the one or more assets 110 and interactions between the one or more assets 110. In some embodiments, the one or more instructions which when executed by at least one processor 202 may cause the at least one processor 202 to determine the anomaly data within the correlated asset data of the one or more assets 110 based on the weight factor and anomaly score, using the unsupervised model. The anomaly data may correspond to the deviation of data from normal or expected behavior of the one or more assets 110 within the industrial control network 104 indicating potential problems, security breaches, or inefficiencies within the industrial control network 104.

In some embodiments, the anomaly data determined within the correlated asset data of the one or more assets 110 using the unsupervised model by the at least one processor 202 that may be further configured to convert one or more columns of the correlated asset data into the numeric value. The one or more columns may be converted into the numeric value, using the label encoder. The one or more columns may correspond to, but is not limited to, time, asset, activity, information, asset node ID, asset description, badge access 304 insights, and video surveillance 306 associated with the one or more assets 110. In some embodiments, the at least one processor 202 may be configured to assign the weight factor to each of the one or more columns. The weight factor may be assigned using the random forest technique. Further, the at least one processor 202 may be configured to determine the anomaly score for each correlated asset data based at least on the assigned weight and the predefined threshold value. The anomaly score may indicate the degree of anomaly of the correlated asset data. Thereafter, the at least one processor 202 may be configured to determine the anomaly data within the correlated asset data based at least on the anomaly score.

In some embodiments, the one or more instructions which when executed by at least one processor 202 may cause the at least one processor 202 to categorize the determined anomaly data into the one or more groups of anomaly data based at least on the number of clusters, using at least the supervised or unsupervised model. In some embodiments, the one or more instructions which when executed by at least one processor 202 may cause the at least one processor 202 to assign the weight to each of the one or more groups of anomaly data. In some embodiments, the one or more instructions which when executed by at least one processor 202 may cause the at least one processor 202 to determine whether the weight assigned to each of the one or more groups is above the preset threshold value. The preset threshold value may correspond to the minimum value above which the anomaly is detected.

In some embodiments, the one or more instructions which when executed by at least one processor 202 may cause the at least one processor 202 to generate the alert associated with each of the one or more groups, for the user upon determining the weight assigned to each of the one or more groups is above the preset threshold value. The alert associated with each of the one or more groups may correspond to one or more anomalous events detected within the industrial control network 104.

The present disclosure may ensure efficient and automated processing of data and alerts. Secondly, the real-time reception of asset data, encompassing various parameters like identification, configuration, operational status, health, diagnostics, time, and location, may enable instantaneous monitoring and analysis, enhancing overall network visibility and responsiveness. The correlation of asset data with the predefined functional data may allow for a deeper understanding of asset behaviors and interactions, facilitating more accurate anomaly detection. Further, leveraging an unsupervised model to determine anomaly data may enable the system to detect deviations from normal patterns, thereby identifying potential security threats or operational abnormalities. The categorization of anomaly data into groups based on clustering methods may enhance ability of the system to prioritize and address security events effectively. Further, assigning weights to anomaly data groups may allow for the customization of alert thresholds, ensuring that only significant anomalies trigger alerts, thereby reducing false positives and alert fatigue.

Furthermore, by generating alerts associated with anomalous groups, the system may provide timely notifications to users, enabling rapid response and mitigation actions. The preset threshold value mechanism may ensure that only anomalies surpassing a certain severity level prompt alerts, streamlining the incident management process. Correlation of the alert with specific anomalous events within the industrial control network may enable users to pinpoint the nature and location of potential security breaches or operational issues accurately. Overall, the present disclosure may enhance the resilience, security, and operational efficiency of industrial control networks, safeguarding critical infrastructure and assets from cyber threats, and ensuring uninterrupted production processes.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, via at least one processor, asset data from one or more assets of an industrial control network in a real time, wherein the asset data comprises at least one of identification data, configuration data, operational data, health and diagnostics data, time data, or location data associated with the one or more assets;
correlating, via the at least one processor, the asset data received from the one or more assets with a predefined functional data, wherein the predefined functional data corresponds to functionalities of each of the one or more assets and interactions between the one or more assets;
determining, via the at least one processor, anomaly data within the correlated asset data of the one or more assets based at least on a weight factor and an anomaly score, using an unsupervised model;
categorizing, via the at least one processor, the determined anomaly data into one or more groups of anomaly data based at least on a number of clusters, using at least a supervised or unsupervised model;
assigning, via the at least one processor, a weight to each of the one or more groups of anomaly data;
determining, via the at least one processor, whether the weight assigned to each of the one or more groups is above a preset threshold value, wherein the preset threshold value corresponds to a minimum value above which an anomaly is detected; and
generating, via the at least one processor, an alert associated with each of the one or more groups, for a user upon determining the weight assigned to each of the one or more groups is above the preset threshold value, wherein the alert associated with each of the one or more groups of anomaly data corresponds to one or more anomalous events detected within the industrial control network.

2. The method of claim 1, wherein the one or more assets comprise at least one of radar surveillance, badge access, video surveillance, USB insights, host insights, network insights, or network data recorder (NDR).

3. The method of claim 1, wherein the anomaly data corresponds to deviation of data from normal or expected behavior of the one or more assets within the industrial control network indicating potential problems, security breaches, or inefficiencies within the industrial control network.

4. The method of claim 1, wherein determining the anomaly data within the correlated asset data of the one or more assets using the unsupervised model further comprising:
converting, via the at least one processor, one or more columns of the correlated asset data into a numeric value, using a label encoder;
assigning, via the at least one processor, the weight factor to each of the one or more columns, using a random forest technique;
determining, via the at least one processor, the anomaly score for each correlated asset data based at least on the assigned weight and a predefined threshold value, wherein the anomaly score indicates a degree of anomaly of the correlated asset data; and
determining, via the at least one processor, the anomaly data within the correlated asset data based at least on the anomaly score.

5. The method of claim 4, wherein the one or more columns correspond to time, asset, activity, information, asset node ID, asset description, badge access insights, and video surveillance associated with the one or more assets.

6. The method of claim 1 further comprising determining, via the at least one processor, the number of clusters dynamically from the determined anomaly data, using an elbow management technique.

7. The method of claim 1 further comprising determining anomaly data within a respective group of anomaly data using the unsupervised model upon determining the weight assigned to each of the one or more groups is below the preset threshold value.

8. The method of claim 1 further comprising sending, via the at least one processor, the alert to the user for taking an action in response to the one or more anomalous events detected within the industrial control network.

9. A system comprising:
a memory; and
at least one processor communicatively coupled to the memory, wherein the at least one processor is configured to:
receive asset data from one or more assets of an industrial control network in a real time, wherein the asset data comprises at least one of identification data, configuration data, operational data, health and diagnostics data, time data, or location data associated with the one or more assets;
correlate the asset data received from the one or more assets with a predefined functional data, wherein the predefined functional data corresponds to functionalities of each of the one or more assets and interactions between the one or more assets;
determine anomaly data within the correlated asset data of the one or more assets based at least on a weight factor and an anomaly score, using an unsupervised model;
categorize the determined anomaly data into one or more groups of anomaly data based at least on a number of clusters, using at least a supervised or unsupervised model;
assign a weight to each of the one or more groups of anomaly data;
determine whether the weight assigned to each of the one or more groups is above a preset threshold value, wherein the preset threshold value corresponds to a minimum value above which an anomaly is detected; and
generate an alert associated with each of the one or more groups, for a user upon determining the weight assigned to each of the one or more groups is above the preset threshold value, wherein the alert associated with each of the one or more groups correspond to one or more anomalous events detected within the industrial control network.

10. The system of claim 9, wherein the one or more assets comprise at least one of radar surveillance, badge access, video surveillance, USB insights, host insights, network insights, or network data recorder (NDR).

11. The system of claim 9, wherein the anomaly data corresponds to deviation of data from normal or expected behavior of the one or more assets within the industrial control network indicating potential problems, security breaches, or inefficiencies within the industrial control network.

12. The system of claim 9, wherein the anomaly data determined within the correlated asset data of the one or more assets using the unsupervised model by the at least one processor further configured to:
convert one or more columns of the correlated asset data into a numeric value, using a label encoder;
assign the weight factor to each of the one or more columns, using a random forest technique;
determine the anomaly score for each correlated asset data based at least on the assigned weight and a predefined threshold value, wherein the anomaly score indicates a degree of anomaly of the correlated asset data; and
determine the anomaly data within the correlated asset data based at least on the anomaly score.

13. The system of claim 12, wherein the one or more columns correspond to time, asset, activity, information, asset node ID, asset description, badge access insights, and video surveillance associated with the one or more assets.

14. The system of claim 9, wherein the at least one processor is configured to determine the number of clusters dynamically from the determined anomaly data, using an elbow management technique.

15. The system of claim 9, wherein the at least one processor is configured to determine anomaly data within a respective group of anomaly data using the unsupervised model upon determining the weight assigned to each of the one or more groups is below the preset threshold value.

16. The system of claim 9, wherein the at least one processor is configured to send the alert to the user for taking an action in response to the one or more anomalous events detected within the industrial control network.

17. A non-transitory machine-readable information storage medium comprising one or more instructions which when executed by at least one processor cause the at least one processor to:
receive asset data from one or more assets of an industrial control network in a real time, wherein the asset data comprises at least one of identification data, configuration data, operational data, health and diagnostics data, time data, or location data associated with the one or more assets;
correlate the asset data received from the one or more assets with a predefined functional data, wherein the predefined functional data corresponds to functionalities of each of the one or more assets and interactions between the one or more assets;
determine anomaly data within the correlated asset data of the one or more assets based on a weight factor and anomaly score, using an unsupervised model;
categorize the determined anomaly data into one or more groups of anomaly data based at least on a number of clusters, using at least a supervised or unsupervised model;
assign a weight to each of the one or more groups of anomaly data;
determine whether the weight assigned to each of the one or more groups is above a preset threshold value, wherein the preset threshold value corresponds to a minimum value above which an anomaly is detected; and
generate an alert associated with each of the one or more groups, for a user upon determining the weight assigned to each of the one or more groups is above the preset threshold value, wherein the alert associated with each of the one or more groups correspond to one or more anomalous events detected within the industrial control network.

18. The non-transitory machine-readable information storage medium of claim 17, wherein the one or more assets comprise at least one of radar surveillance, badge access, video surveillance, USB insights, host insights, network insights, or network data recorder (NDR).

19. The non-transitory machine-readable information storage medium of claim 17, wherein the anomaly data corresponds to deviation of data from normal or expected behavior of the one or more assets within the industrial control network indicating potential problems, security breaches, or inefficiencies within the industrial control network.

20. The non-transitory machine-readable information storage medium of claim 17, wherein the anomaly data determined within the correlated asset data of the one or more assets using the unsupervised model by the at least one processor further configured to:
convert one or more columns of the correlated asset data into a numeric value, using a label encoder;
assign the weight factor to each of the one or more columns, using a random forest technique;
determine the anomaly score for each correlated asset data based at least on the assigned weight and a predefined threshold value, wherein the anomaly score indicates a degree of anomaly of the correlated asset data; and
determine the anomaly data within the correlated asset data based at least on the anomaly score.
